(19) United States
(12) Patent Application Publication
(10) Pub. No.: US 2006/0020971 A1
(43) Pub. Date: Jan. 26, 2006

(54) Multi channel program guide with integrated progress bars

(76) Inventor: Thomas Poslinski, San Diego, CA (US)

Correspondence Address: Steven L. Nichols;Rader, Fishman, & Grauer PLLC, River Park Corporate Center One, River Front Pkwy., Ste 150, South Jordan, UT, 84095, US

(21) Appl. No.: 10/897,167

(22) Filed: Jul. 22, 2004

(51) Int. Cl. H04N 5/445; G06F 13/00; G06F 3/00

(52) U.S. Cl. 725/44; 725/40; 725/56

(57) ABSTRACT

In one of many possible embodiments, the present invention provides a method and system for providing information about media content being broadcast on multiple channels during a number of time segments. The media content includes a plurality of media content instances. A program guide for multiple channels is displayed showing program information corresponding to a number of the plurality of media content instances. A number of progress bars are also displayed and are superimposed on top of the program guide. The progress bars graphically represent the duration of a recorded portion of the media content that is received by one or more tuners and stored in one or more corresponding live cache buffers.

### BACKGROUND

The advent of computers, interactive electronic communication, the Internet, and other advances in the digital realm of consumer electronics have resulted in a great variety of programming, recording, and viewing options for users who view media content such as television programs. In implementing such enhanced programming, the set-top box (STB) has become an important computing device for accessing media content services and the media content within those services. In addition to supporting traditional analog broadcast video functionality, STBs may also support an increasing number of two-way digital services such as video-on-demand and personal video recording.

An STB is typically connected to a cable or satellite, or generally, a subscriber television system, and includes hardware and software necessary to provide the functionality of the subscriber television system at the user's site. The STB typically includes a processor, one or more tuners, communication components, and memory and is connected to a television or other display device, such as a personal computer. While many STBs are stand-alone devices that are externally connected to a television, an STB and/or its functionality may be integrated into a television or personal computer or even an audio device such as a programmable radio, as will be appreciated by those of ordinary skill in the art.

STBs are typically capable of providing users with a very large number and variety of media content choices. As the number of available media content choices increases, viewing conflicts arise whereby the user must choose between watching two or more media content instances (e.g. discrete, individual instances of media content such as, for a non-limiting example, a particular television show or “program”), all of which the user may like to view. Further, because of the large number of viewing choices, the user may miss viewing opportunities. On screen program guides and buffering of media content instances in memory or other storage device (e.g. hard disk drive) coupled to the STB have provided some relief from the conflict in viewing choices while providing personal video recording functionality. However, current buffering mechanisms for personal video recording are confusing to the user. Furthermore, on screen program guides are currently confusing to the user when the STB includes multiple tuners.

As mentioned, an STB may include a personal video recording (PVR) application that provides for media content recording functionality by enabling the temporary writing to, and if requested, more permanent recording to a storage device. A PVR application is also known as a Digital Video Recording (DVR) application. The PVR application may be integrated into the STB or it may be a stand-alone unit known as a personal video recorder. A typical PVR application allows the user to view the media content in trick play modes. Trick play modes allow the user to watch media content in a non-linear fashion by recording the media content in a temporary memory buffer, often called a live cache buffer, and then replaying the recorded media content in a manner other than a normal, sequential replay. Trick play modes include, but are not limited to, slow motion, fast motion, reverse play, fast forward play, instant replay, jumping, pausing of live broadcast, and scanning.

Some STBs with PVR capability include multiple tuners which allow a user to simultaneously record two or more channels of media content in one or more live cache buffers. However, it is currently difficult for a user to navigate between channels that are being simultaneously recorded in live cache buffers without accidentally switching to a channel that is not currently being live cache buffered. This unintentional switching of channels is often undesirable because the previously stored media content of the live cache buffer associated with that tuner is automatically erased.

In a typical PVR application, a progress bar is a graphical tool that is used to illustrate how much media content has been recorded during a particular time window. The length of the progress bar may correspond to the amount of media content that has been recorded in a live cache buffer. However, a number of difficulties arise in operating a STB having a PVR application. For example, it is currently difficult for a user to display program information corresponding to the media content that is currently being recorded and tracked by a progress bar. Furthermore, it is currently difficult for a user to navigate through a program guide without accidentally switching to a channel that is not currently being live cache buffered.

### SUMMARY

In one of many possible embodiments, the present invention provides a method and system for providing information about media content being broadcast on multiple channels during a number of time segments. The media content includes a plurality of media content instances. A program guide for multiple channels is displayed showing program information corresponding to a number of the plurality of media content instances. A number of progress bars are also displayed and are superimposed on top of the program guide. The progress bars graphically represent the duration of a recorded portion of the media content that is received by one or more tuners and stored in one or more corresponding live cache buffers.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram of an exemplary set-top box according to one exemplary embodiment of the present invention.

FIG. 2 is an exemplary user input device may be used in connection with the present invention according to one exemplary embodiment of the present invention.

FIG. 3 illustrates a graphical user interface (GUI) displayed on the display device that assists the user in navigating to, and between, various channels having media content according to one exemplary embodiment of the present invention.

FIG. 4 illustrates a program guide that occupies only the lower half of the viewing screen of the display device so that the upper half of the viewing screen may be used to simultaneously show a particular media content instance of a selected channel according to one exemplary embodiment of the present invention.

FIG. 5 illustrates a GUI displayed on the display device wherein the current time has changed and wherein the entire progress bar has shifted to the right according to one exemplary embodiment of the present invention.

FIG. 6 illustrates a media content instance that has been paused according to one exemplary embodiment of the present invention.

FIG. 7 illustrates that the program guide has been scrolled to the right such that additional program information related to media content to be shown at a later time is displayed on the screen according to one exemplary embodiment of the present invention

FIG. 8 is a flow chart illustrating an exemplary method of displaying a program guide with one or more superimposed progress bars on a display device according to one exemplary embodiment of the present invention.

FIG. 9 shows that a user may select a “categories” button that is preferably included on the program guide main viewing screen and/or on the user input device according to one exemplary embodiment of the present invention.

FIG. 10 shows an exemplary program guide showing program information related only to those channels being live cache buffered according to one exemplary embodiment of the present invention.

FIG. 11 is a flow chart illustrating an exemplary method of displaying a program guide showing program information related only to those channels being live cache buffered and with one or more superimposed progress bars, according to one exemplary embodiment of the present invention.

FIG. 12 illustrates that a user may designate which media content instance is to be recorded by using the program guide with the superimposed progress bars.

Throughout the drawings, identical reference numbers designate similar, but not necessarily identical, elements.

### DETAILED DESCRIPTION

A method and system for providing information about media content being broadcast on multiple channels during a number of time segments are described herein. The media content includes a plurality of media content instances. A graphical user interface (GUI) including a multi-channel program guide and a number of superimposed progress bars is displayed on the viewing surface of a display device. The program guide shows program information corresponding to a number of the plurality of media content instances. The progress bars graphically represent the duration of a recorded portion of the media content that is received by one or more tuners and stored in one or more corresponding live cache buffers. The GUI allows a user to easily navigate through various media content instances (e.g. television programs) and/or view the media content instances using trick play modes. The GUI further allows a user to easily designate a particular media content instance as one that is to be permanently recorded. The program guide may be configured such that program information corresponding to only those channels that are being live cache buffered is displayed.

In the following description, for purposes of explanation, numerous specific details are set forth in order to provide a thorough understanding of the present system and method. It will be apparent, however, to one skilled in the art that the present system and method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

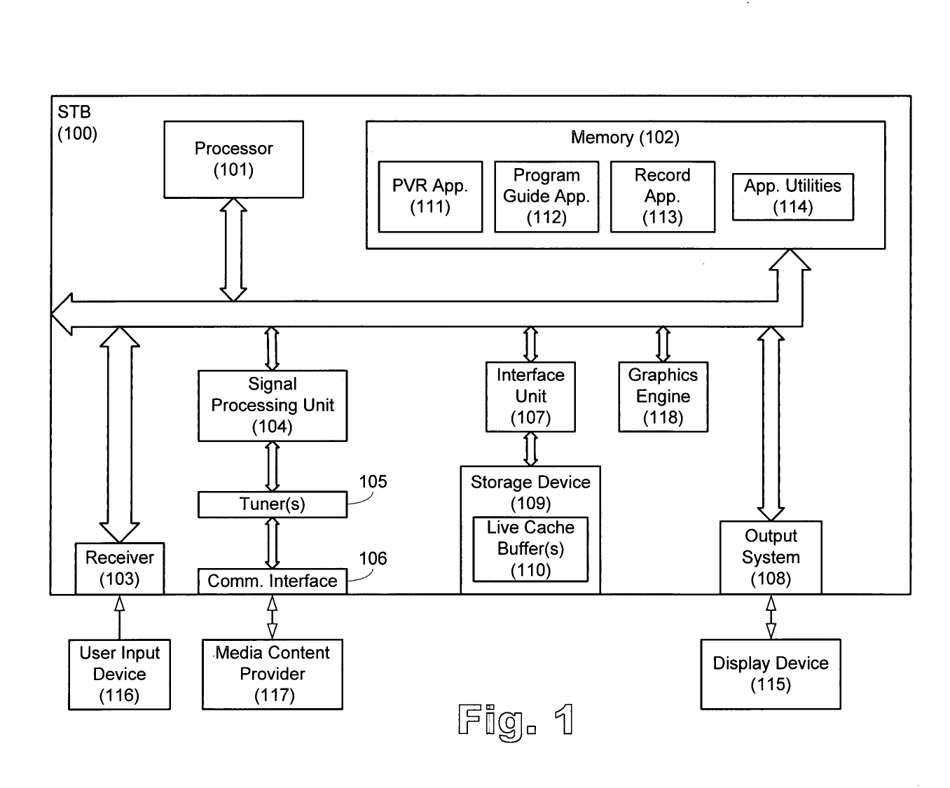

FIG. 1 is a block diagram of an exemplary set-top box (STB) (100) according to an exemplary embodiment of the present invention. An STB (100) may also referred to as a home communication terminal (HCT) or as a digital home communication terminal (DHCT). As used herein and in the appended claims, unless otherwise specifically denoted, the term “set-top box” will be used to refer expansively to all possible receivers that receive and decode digital and/or analog media content. It will be understood that the STB (100) shown in FIG. 1 is merely illustrative and should not be construed as implying any limitations upon the scope of the preferred embodiments of the invention.

As shown in FIG. 1, the STB (100) may include a communication interface (106) configured to receive media content from a media content provider (117). The media content provider (117) may provide various types of media content via a satellite or cable system (not shown). The media content may include, but is not limited to, television programs, pay-per-view services, video-on-demand programming, Internet services, and audio programming.

The STB (100) may also include one or more tuners (105) configured to tune into a particular television channel or frequency to display media content and for sending and receiving various types of data or media content to and from the media content provider (117). According to an exemplary embodiment of the present invention, the STB (100) may include multiple tuners (105) such that multiple channels of media content may be processed and/or shown on a display device (115). For example, the STB (100) may include a first tuner configured to receive an analog video signal corresponding to a first media content instance and a second tuner configured to simultaneously receive a digital compressed stream corresponding to a second media content instance. The STB (100) may have any number of tuners (105) configured to receive any kind of media content according to one embodiment of the present invention.

The STB (100) may also include one or more processors, such as processor (101) configured to control operations of the STB (100), and an output system (108) configured to drive the display device (115). The display device (115) may be a television, computer monitor, or any other device configured to display or play the media content. The STB (100) may also include a signal processing unit (104) configured to process the media content. The signal processing unit (104) may include a demodulating and parsing system (not shown) for demodulating and parsing the media content. In one embodiment, the STB (100) may include multiple signal processing units (104) each corresponding to one of the tuners in the tuner system (105). The STB (100) may also include one or more compression and/or multiplexing units (not shown) for multiplexing various media content streams into a transport stream or the like.

One or more programmed applications (111-113) may be executed by a user of the STB (100) by utilizing the computing resources in the STB (100). The applications, or application clients, may be resident in memory (102). The memory (102) may be FLASH memory, DRAM memory, or a combination of FLASH and DRAM memory, for example. Applications (111-113) stored in memory (102) may be executed by the processor (101). Data generated by an application may be stored in the memory (102) or in a storage device (109) during the course of application execution. The memory (102) may also include application utilities (114) useful to the applications. The utilities (114) may include a timer manager, a configuration manager, a database manager, and other utilities depending on the particular applications included in the STB (100).

One of the applications may be a program guide application (112) configured to generate an interactive program guide that is displayed on the display device (115). In one embodiment, the program guide application may be a part of a PVR application (111). An exemplary program guide, as will be described below, is a graphical user interface (GUI) that performs various functions including allowing a user to select and view program information associated with various media content. Another one of the applications may be a record application (113). The record application (113) may be configured to permanently and/or temporarily record media content in one or more buffers. The program guide and record applications (112, 113) will be described below.

The STB (100) may also include a personal video recording (PVR) application (111). According to an exemplary embodiment, the PVR application (111) may be integrated into the STB (100), as shown in FIG. 1, or it may be a stand-alone unit. A stand-alone PVR may be coupled to an STB (100) or it may be used in place of an STB (100). As used herein and in the appended claims, the term “PVR application” will be used to refer to any application or device configured to record media content and/or allow the viewing of media content in trick play mode. Trick play modes include, but are not limited to, slow motion, fast motion, reverse play, fast forward play, instant replay, jumping, pausing of live broadcast, and scanning. In the examples contained herein, it will be assumed that the PVR application (111) is integrated into the STB (100) for illustrative purposes only. In one embodiment, the program guide application (112) and/or the record application (113) may be integrated into the PVR application (111).

The PVR application (111) provides for media content recording functionality by enabling the temporary writing to, and if requested, more permanent recording to a storage device (109). The storage device (109) may be a hard drive, optical disc, or other non-volatile storage unit. The storage device (109) of FIG. 1 is shown to be a part of the STB (100) for illustrative purposes only. It will be understood that the storage device (109) may be an external storage device.

The STB (100) may also include a graphics engine (118) configured to generate graphics to be displayed on the display device (115). The graphics may include an on screen program guide, a progress bar, and other applications. For example, the PVR and program guide applications (111, 112) may cause the graphics engine (118) to generate one or more progress bars superimposed on an on screen program guide, as will be explained in detail below.

In one exemplary embodiment, media content received at each tuner (105) is temporarily buffered, or stored, in a live cache buffer (110). If there are multiple tuners (105), there may be a live cache buffer (110) corresponding to each of the tuners (105). As shown in FIG. 1, the live cache buffer (110) may be a part of the storage device (109) (e.g. a reserved portion of a hard dive). In an alternative embodiment (not shown), the live cache buffer (110) may reside in memory (102) or in a storage device external to the STB (100). Media content received into the live cache buffer (110) has a temporary recording designation. In other words, the media content stored in the live cache buffer (110) will either be deleted or retained through election by the user as a permanent recording. A permanent recording will be understood to mean media content that is stored for an extended period of time as decided by the user. Permanent recordings may be stored in non-buffer portions of the storage device (109). The conversion of a media content instance from being temporarily stored in the live cache buffer (110) to being permanently recorded will be discussed below.

As will be understood by one skilled in the art, there is a time duration associated with the live cache buffer (110) corresponding to the quantity of data that the live cache buffer (110) is configured to store. This time duration will be referred to as a “live cache time window” herein and in the appended claims. The length of the live cache time window may be specified by the user, according to one embodiment. For example, the user may specify a live cache time window of one hour. In this example, the live cache buffer (110) will be configured to store a quantity of media content data representing one hour. The length of the live cache time window as specified by the user may vary as best serves a particular application and may be limited by the size of the storage unit of which the live cache buffer (110) is a part and by the capabilities of the STB (100) and its components.

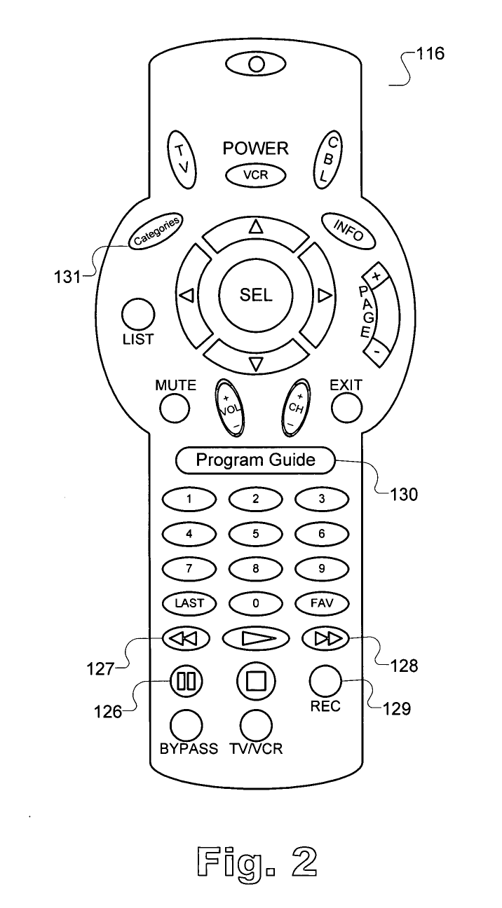

An exemplary user input device (116) is shown in FIG. 2. The input device (116) may be a remote control, as shown in FIG. 2, or any other type of user input device such as a group of buttons (not shown) affixed to the STB (100), a touch screen input device (not shown) displayed on the display device (115), a keyboard device, or a voice activated device. The input device (116) allows a user to control viewing options and trick play modes of the media content. For example, rewind (127) and fast-forward buttons (128) enable a user to access buffered media content instances in the live cache buffer (110). A record button (129) may also be included which enables the user to designate as permanently recorded any media content instance buffered in one of the live cache buffers (110). A pause button (126) may enable the user to pause a media content instance, or pause during a search for a particular media content instance. A program guide button (130) may be configured to evoke a full or partial screen program guide on the display device (115). Many alternative methods of providing user input may be used including a remote control device with different buttons and/or button layouts. The embodiments of the invention described herein are not limited by the type of device used to provide user input.

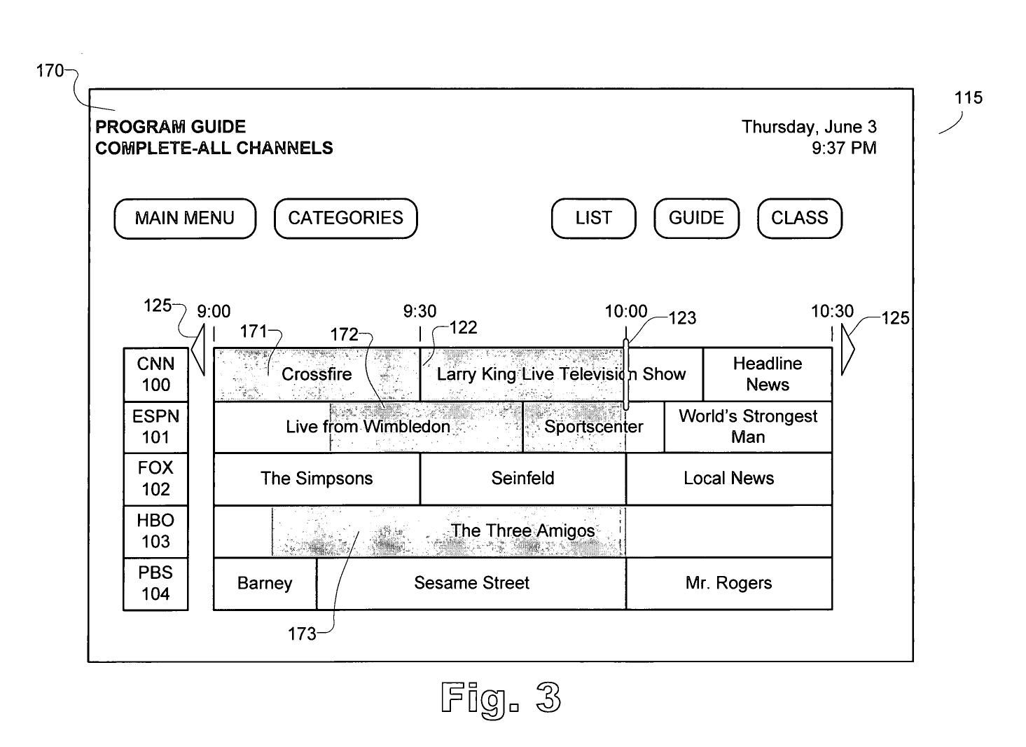

As mentioned, the STB (100; FIG. 1) may include multiple tuners (1 05; FIG. 1) each tuned to a different channel. The media content on each of the channels to which the tuners are tuned may be temporarily recorded in one of the live cache buffers (110; FIG. 1). FIG. 3 illustrates an exemplary embodiment of the present invention wherein a GUI is displayed on the display device (115) that assists the user in navigating to, and between, various channels having media content. The GUI may be configured so that the user may quickly view which channels are currently being recorded in live cache buffers (110; FIG. 1) and so that the user may easily navigate to, and between, media content instances stored in each of the live cache buffers (110). The display device (115) in FIG. 3 is a television for illustrative purposes.

Specifically, as shown in FIG. 3, the GUI includes a number of progress bars (171-173) superimposed on top of a full screen program guide (170) such that the user may conveniently view which of the channels are being live cache buffered. The display of the program guide (170) may be invoked, for example, by the user upon pressing a program guide button (130; FIG. 2) or a similar button on a user input device (116; FIG. 2). The program guide (170) graphically shows program information relating to media content that is showing, has shown, or that will be shown on the channels available to the STB (100; FIG. 1) during a specified time period. As shown in FIG. 3, the progress bars (171-173) are superimposed on top of the program guide (170) and may be shaded or of a unique color such that a user may visually distinguish the progress bars (171-173) from the program guide (170).

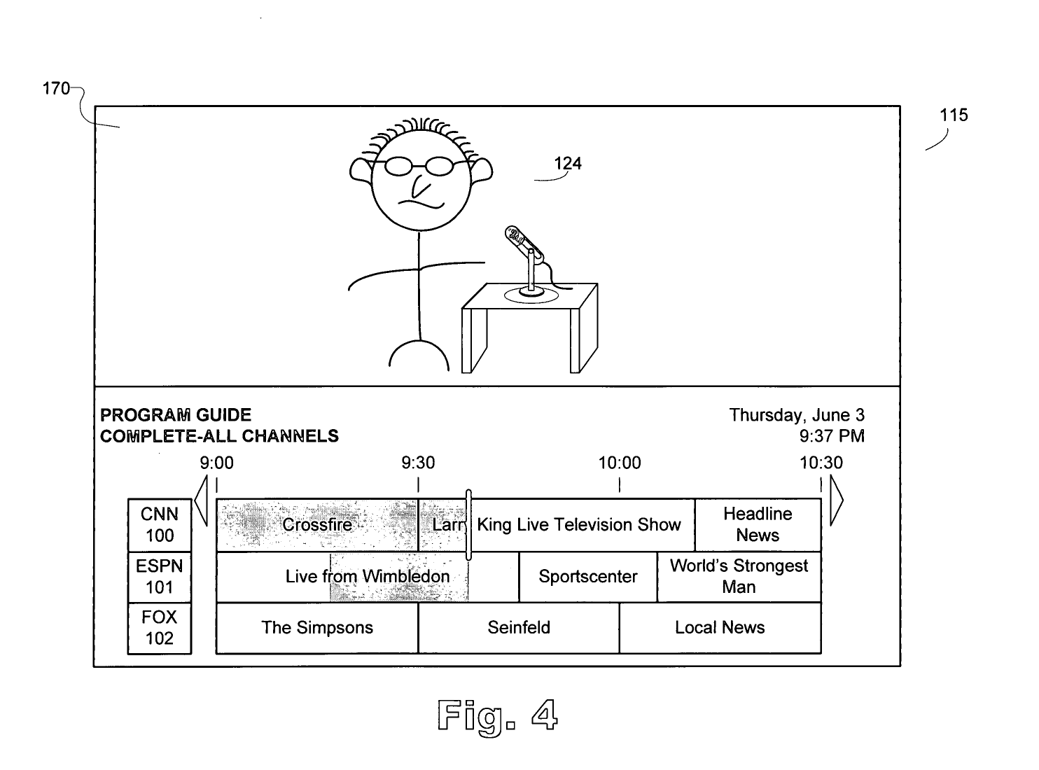

The full screen program guide (170) may occupy the entire viewing screen of the display device (115), as shown in FIG. 3, or, alternatively, only a portion of the entire viewing screen. For example, FIG. 4 illustrates a program guide (140) that occupies only the lower half of the viewing screen of the display device (115) so that the upper half of the viewing screen may be used to simultaneously show a particular media content instance (141) of a selected channel. The terms “full screen program guide” and “program guide” will be used interchangeably herein and in the appended claims, unless otherwise specifically denoted, to refer to any on-screen GUI that shows program information for multiple channels.

Returning to FIG. 3, the program guide (170) may be displayed in a grid-like style with a number of blocks of program information corresponding to media content being shown on a number of channels. For example, the program guide (170) shows program information corresponding to media content instances being broadcast or shown on channels 100-104. The program guide (170) shows program information corresponding to five channels in FIG. 3 for illustrative purposes. The number of rows in the program guide (170) may vary as best serves a particular application.

As shown in FIG. 3, the program information shown in the program guide (170) may include the title of the media content instances. For example, the program guide (170) shows that channel 100 (CNN) shows Crossfire, Larry King Live, and Headline News between 9:00 and 10:30. In addition, the program guide (170) may also show the name of the channel currently being displayed, as shown in FIG. 3, and other types of program information (not shown). Program information may include, but is not limited to, genre information, ratings information, program start and stop times, program descriptions, and other pertinent program information text.

In one embodiment, a time scale may be included in the program guide (120). The time scale is relative to the time segmentation of the program guide (170). For example, in FIG. 3, program information is shown for three one-half hour time segments starting at 9:00 and ending at 10:30. The time scale and number of time segments included in the program guide (170) may vary as best serves a particular application and may be specified by the user. For example, each time segment may represent an hour instead of a half hour if the user wants to view program information for a larger time window.

Furthermore, as shown in FIG. 3, the program boundaries may be represented by vertical separators. For example, a vertical separator (122) is located in the first row of the program guide (170) at a position corresponding to 9:30, the time when Crossfire ends and when Larry King Live begins. In one embodiment, the vertical separators are always viewable to the user while the program guide (170) is being displayed.

As is known in the art, the user may scroll up or down to display program information corresponding to channels not currently shown on the program guide (170). For example, the program guide (170) of FIG. 3 currently shows program information for each of the channels 100 through 104. If the user desires to see program information for channel 105 (not shown), he or she may scroll down until the program information is displayed for channel 105. The user may traverse through the program guide (170) without changing the channel that is currently being viewed, according to an exemplary embodiment. The particular layout of the program guide (170) may vary as best serves a particular application. Furthermore, in one embodiment, horizontal scroll bars (125) may be included in the program guide (70) so that the user may scroll backwards and forwards in time to see program information at times not currently being displayed. The scroll bars (125) may be implemented and displayed in a variety of manners that are known in the art.

A progress bar, such as one of the progress bars (171-173), graphically illustrates the amount of media content that has been recorded in a live cache buffer (110). For example, the progress bar (171) of FIG. 3 shows the user that the PVR application (111) began recording the media content being shown on channel 100 (CNN) at 9:00. As time progresses, the length of the progress bar (171) increases to visually indicate to the user the amount, in minutes, of media content that has been recorded in the live cache buffer (110). In one embodiment, the right-most edge of the progress bar (171) indicates the current time. For example, in FIG. 3, the right-most edge of the progress bar (171) is positioned at approximately 10:00. Thus, the current time in FIG. 3 is 10:00. The amount of media content that may be stored in the live cache buffer (110) (i.e. the live cache time window) is preferably user-definable and is limited by the size of the storage unit of which the live cache buffer (110) is a part and by the capabilities of the STB (100) and its components. Typical durations of the live cache time window include, but are not limited to a half hour, an hour, two hours, or three hours. The length of the live cache time window will vary as best serves a particular application. For example, the length of the live cache window in FIG. 3 is one hour.

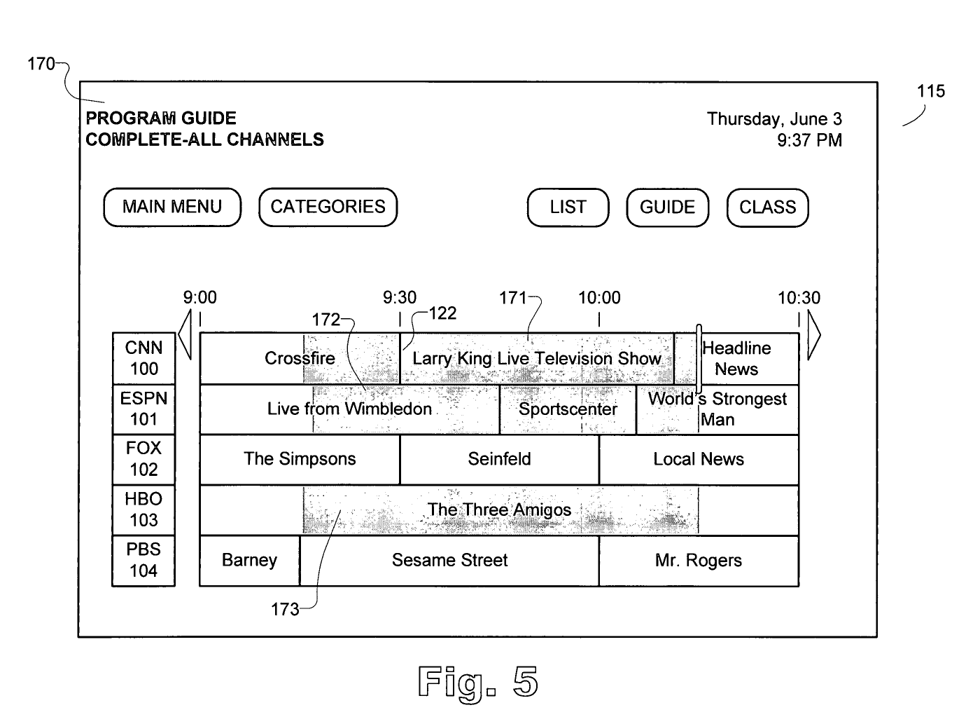

Once a progress bar (e.g. 171) has reached a length equal to the defined live cache time window, the entire progress bar (171) moves across the program guide (170) such that the right edge of the progress bar (171) stays with the current time. For example, if the current time in FIG. 3 changes from 10:00 to 10:15, the entire progress bar (171) shifts to the right such that the progress bar (171) starts at 9:15 and ends at 10:15, as shown in FIG. 5. Furthermore, as the current time progresses, previously recorded media content residing in the live cache buffer (110) is erased in a first-in first-out (FIFO) fashion so that there is space in the live cache buffer (110) for the media content instance being shown at the current time to be recorded. FIG. 5 also shows that the other two progress bars (172, 173) superimposed on the program guide (170) have also grown in length and shifted to the right so that their respective right edges remain in line with the current time.

Returning to FIG. 3, the progress bars (171-173) also graphically indicate to the user which channels are currently being recorded in live cache buffers (110; FIG. 1). For example, the progress bars (171-173) superimposed on the program guide (170) of FIG. 3 show that channels 100, 101, and 103 are currently being recorded in live cache buffers (110; FIG. 1). The progress bars (171-173) further indicate amount of media content that has been stored in each of the live cache buffers 110; FIG. 1). For example, the progress bars (171-173) of FIG. 3 show that the PVR application (111; FIG. 1) began recording channel 100 at 9:00, channel 101 at approximately 9:15, and channel 103 at approximately 9:10.

By superimposing the progress bars (171-173) on the program guide (170), the user may also easily see which channels are not being currently recorded. For example, the user may think that the media content instance Seinfeld is currently being recorded in a live cache buffer (110; FIG. 1). However, upon invoking the display of the program guide (170) with superimposed progress bars (171-173), the user may instantly recognize that channel 102 is not being currently recorded because there is no progress bar superimposed on channel 102. The user may then cause one of the tuners (105; FIG. 1) to tune to channel 102 so that Seinfeld may be temporarily recorded in a live cache buffer (110; FIG. 1) for PVR purposes. It is important to note that if the user causes one of the tuners (105; FIG. 1) to tune to a new channel that is not currently being live cache buffered, the previously stored media content of the live cache buffer (110; FIG. 1) associated with that tuner is automatically erased and the PVR application (111; FIG. 1) begins filling the live cache buffer (110; FIG. 1) with media content associated with the new channel.

As shown in FIG. 3, a progress indicator (123) may be displayed and positioned over or on top of the row in the program guide (170) corresponding to the channel that is currently being displayed. For example, CNN (channel 100) is currently being displayed in the example of FIG. 3. Hence, the progress indicator (123) is positioned over the block of the program guide (170) corresponding to CNN (channel 100). The progress indicator (123) graphically indicates to the user the location in the live cache buffer (110) of the media content instance that is currently being displayed. For example, in FIG. 3, the progress indicator (123) indicates that the user is viewing the media content instance in real-time as it is being buffered. In one embodiment, the user may subsequently select a different channel as the channel that is being currently viewed. In this instance, the progress indicator (123) would be displayed on the portion of the program guide (170) corresponding to the newly selected channel. In one embodiment, the user may use trick modes to view the media content of the channel being currently viewed.

The progress indicator (123) may be a solid line, as shown in FIG. 3. In an alternative embodiment, the progress indicator (123) may be any shape, such as a triangle, and may be located above, below, or on top of the progress bar (121). In general, the progress indicator (123) may be any symbol that allows the user to quickly identify the location in the live cache buffer (110) of the media content instance that is currently being displayed.

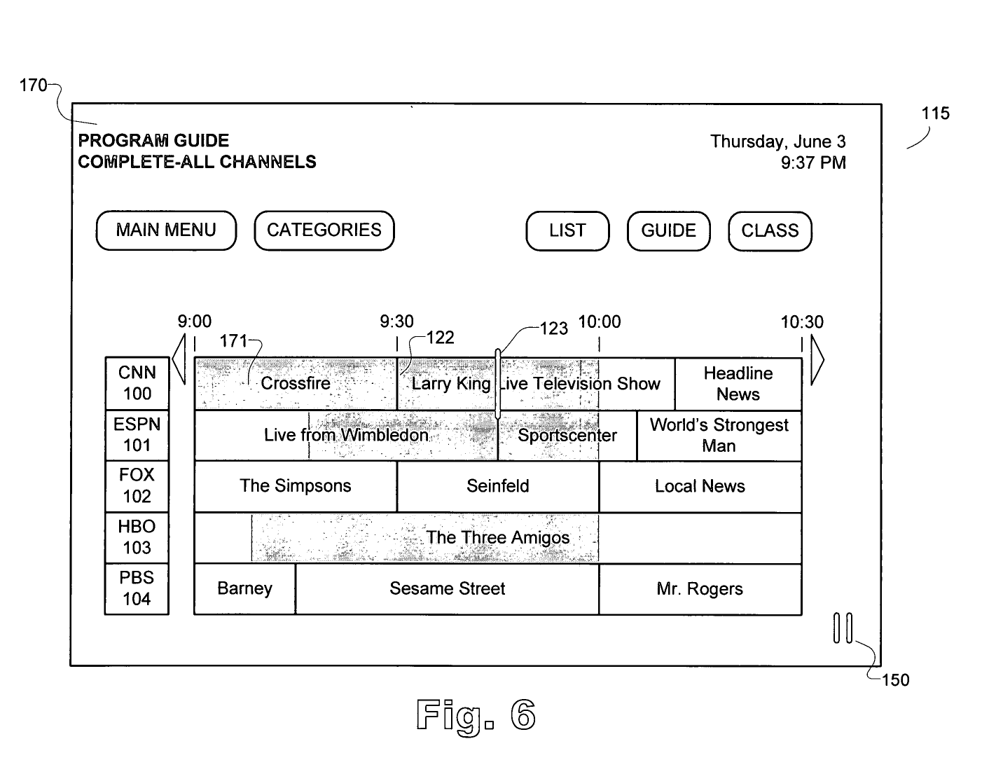

The progress indicator (123) is especially useful to the user when the user is viewing the media content instance in trick play mode. For example, FIG. 6 illustrates a media content instance that has been paused at about 9:45, as shown by the pause symbol (150). As shown in FIG. 6, the progress indicator (123) is positioned at about 9:45 on the progress bar (171). As time progresses, the progress bar (171) either grows or moves across the program guide (170) while the progress indicator (123) stays at the 9:45 position. The user may easily move the position of the progress indicator (123) and view different portions of the media content stored in the corresponding live cache buffer (110).

As mentioned, the duration of the live cache time window may be defined by the user. If the defined live cache time window duration is larger than the length of the displayed program guide (170), the user may use the scroll features already described to quickly navigate the progress indicator (123) to a desired location.

In one embodiment, program information corresponding to media content recorded in each of the live cache buffers (110; FIG. 1) may also be stored in the live cache buffers (110; FIG. 1) or in a separate program information database (not shown). For example, program information for Crossfire and Larry King Live may be stored in the live cache buffer (110; FIG. 1) containing media content shown on CNN (channel 100) or in a separate program information database. In one embodiment, this program information is stored in the buffer or database until the corresponding media content is deleted from the live cache buffers (110; FIG. 1). By storing the program information corresponding to recorded media content, the program information may be rendered by the graphics engine (118; FIG. 1) as part of the displayed program guide (170).

The program information corresponding to channels not being cached (e.g. channels 102 and 104 in FIG. 3) may also be stored in a live cache buffer (110; FIG. 1) or in a program information database (not shown), according to an exemplary embodiment, and displayed in the program guide (170) for time blocks previous to the currently showing time block. In an alternative embodiment, the program information corresponding to channels not being cached is not stored. In this case, a text message such as “Program Information Not Available” may be displayed in time blocks for which there is no stored program information. For example, the message “Program Information Not Available” may be displayed instead of “Barney” in the first block shown corresponding to channel 104 of FIG. 3.

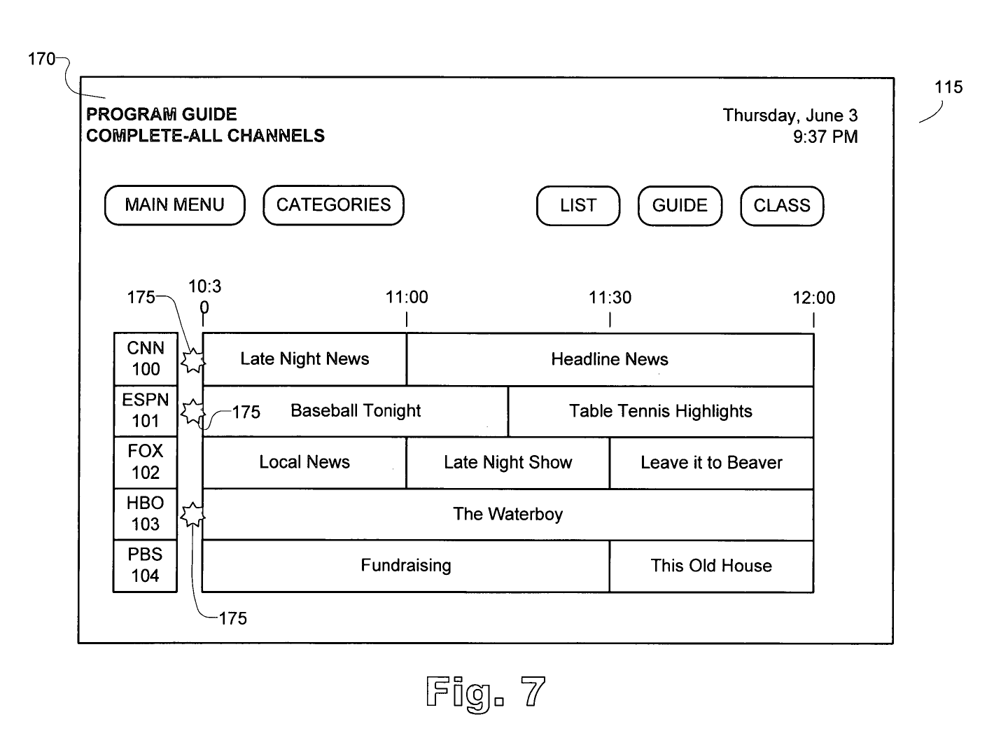

In some instances, the user may scroll the program guide (170) to the right to view program information related to media content that is going to show in the future. If the user scrolls to the right such that the current time block is no longer shown on the screen, no progress bars can be displayed because progress bars represent media content that has already been shown and recorded. For example, FIG. 7 illustrates that the program guide (170) has been scrolled to the right such that program information related to media content that is to be shown between 10:30 and 12:00 is shown on the screen. However, the current time is 10:00, as indicated by the right-most edge of the progress bars (171-173) in FIG. 3. Hence, no progress bars are shown on the screen in FIG. 7. In one embodiment, as shown in FIG. 7, icons (175) may be displayed on the row corresponding to channels that are being live cache buffered to indicate to the user that those channels are being live cache buffered. For example, in FIG. 7, an icon (175) is displayed in the rows representing channels 100, 101, and 103 to show that they are being live cache buffered. The icons (175) may be positioned anywhere in the program guide as long as they indicate to the user which channels are being live cache buffered. The icons (175) may be of any shape and/or style as best serves a particular application.

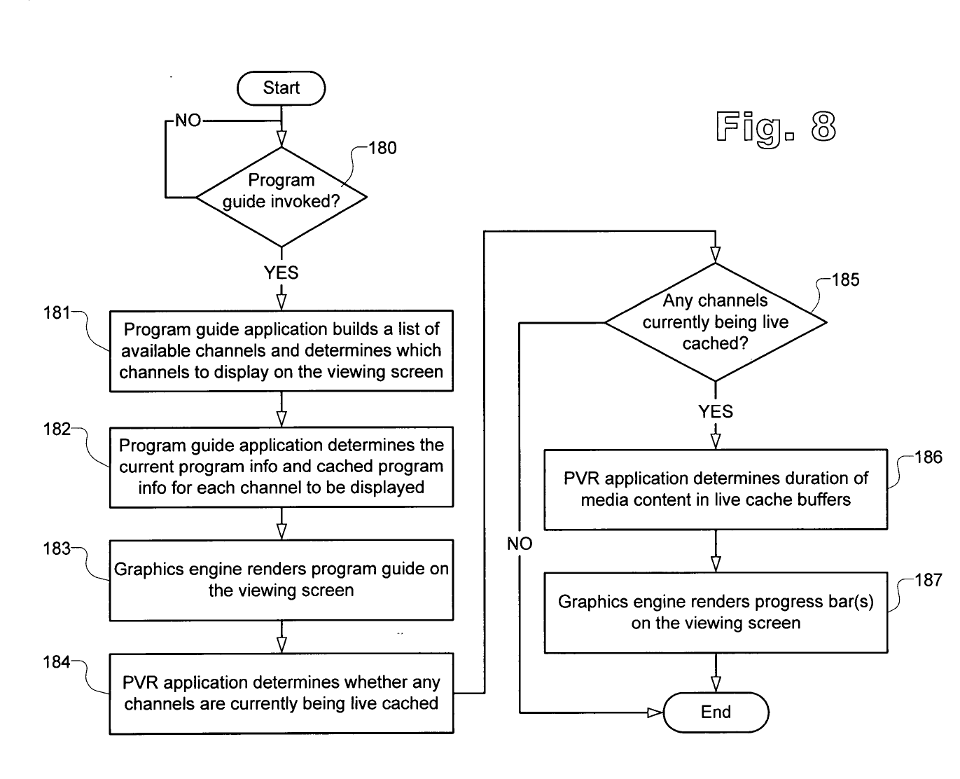

FIG. 8 is a flow chart illustrating an exemplary method of displaying a program guide with one or more superimposed progress bars on a display device, according to an exemplary embodiment of the present invention. The steps shown in FIG. 8 may be performed in any order and may be performed by various applications. Furthermore, the steps are exemplary only and may be added to or modified as best serves a particular application.

As shown in FIG. 8, the method preferably begins when the program guide is invoked by the user (YES, step 180). The program guide application then builds a list of available channels and determines which channels are to have program information displayed on the viewing screen (step 181). The program guide application then determines the current program information and cached program information for each channel to be displayed (step 182). With this information, the graphics engine may render the program guide on the viewing screen (step 183). The program information determined in step 182 is included in the program guide rendered in step 183.

The PVR then determines whether any of the channels are currently being recorded in a live cache buffer (step 184). If one or more channels are being live cached (YES, step 185), the PVR application determines the duration of the media content in the live cache buffers (step 186). The graphics engine may then render one or more appropriately sized progress bars on the viewing screen (step 187).

As mentioned, if the user of an STB (100; FIG. 1) with multiple tuners (105; FIG. 1) causes one of the tuners (105; FIG. 1) to tune to a new channel that is not currently being live cache buffered, the previously stored media content of the live cache buffer (110; FIG. 1) associated with that tuner is automatically erased and the PVR application (111; FIG. 1) begins filling the live cache buffer (110; FIG. 1) with media content associated with the new channel. If the user is navigating through a full-screen program guide, he or she may accidentally select a channel that is not currently being live cache buffered and thereby lose media content already in the live cache buffer (110; FIG. 1). To remedy this problem, as described below, a “progress bar guide” category may be selected by the user wherein only those channels currently being live cache buffered are shown on the program guide (170; FIG. 3).

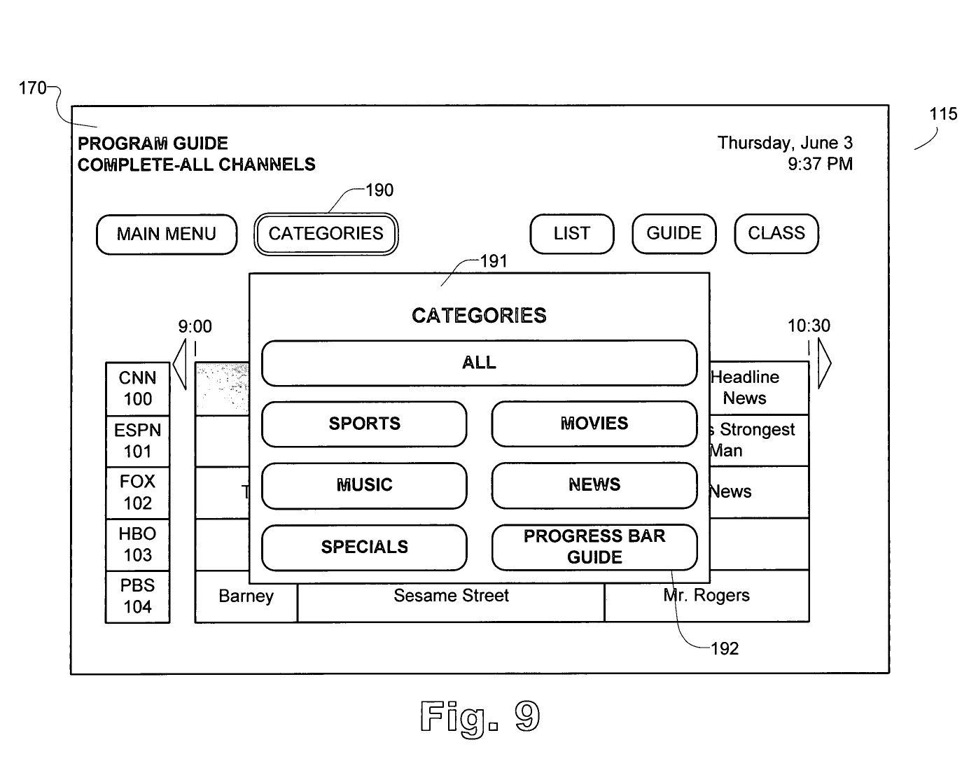

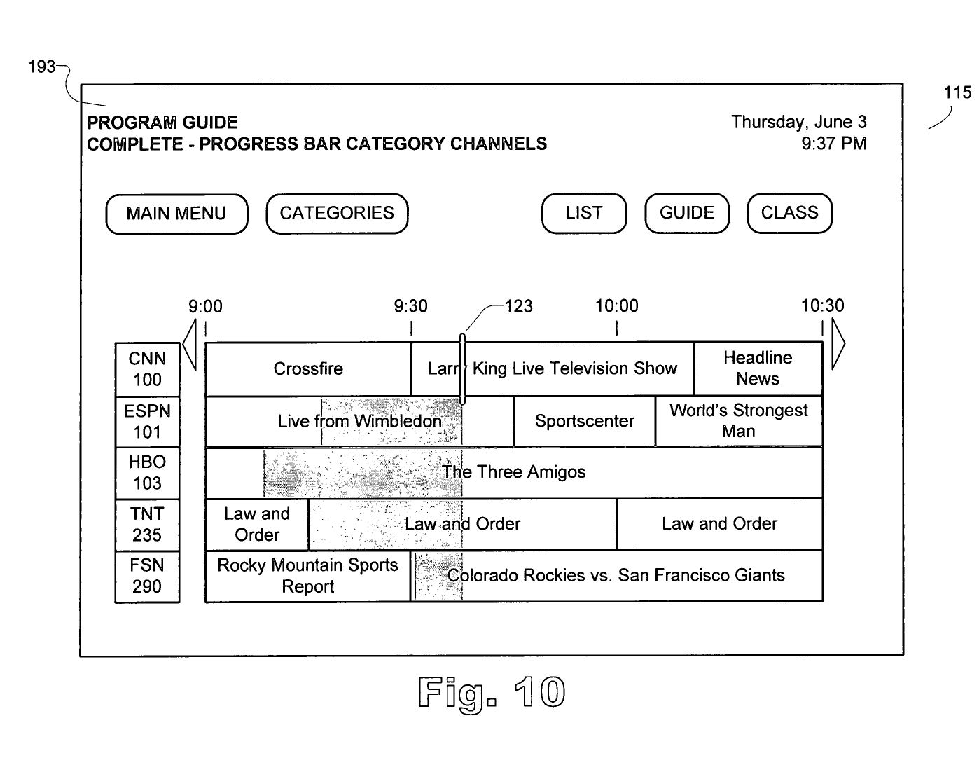

FIG. 9 shows that a user may select a “categories” button (190) that is preferably included on the program guide main viewing screen and/or on the user input device (131; FIG. 2). Upon selection of the “categories button (190), a categories menu (191) may be invoked. A categories menu (191) comprises a number of category options for the user. For example, as shown in FIG. 9, the user may select the “sports” category which causes the program guide (170) to display only those channels showing sports content. In one embodiment of the present invention, a “progress bar guide” category (192) is included in the categories menu (191). Upon selection of the “progress bar guide” category (192), the program guide (170) displays only those channels that are being live cache buffered, as shown in FIG. 10. FIG. 10 shows an exemplary program guide (193) showing program information related only to those channels being live cache buffered. For example, FIG. 10 shows that five channels are currently being live cache buffered. Each of these five channels has an associated progress bar. The “progress bar guide” category allows the user to easily navigate between and select only those channels that are being live cache buffered. The “progress bar guide” category may given a different name according to one embodiment.

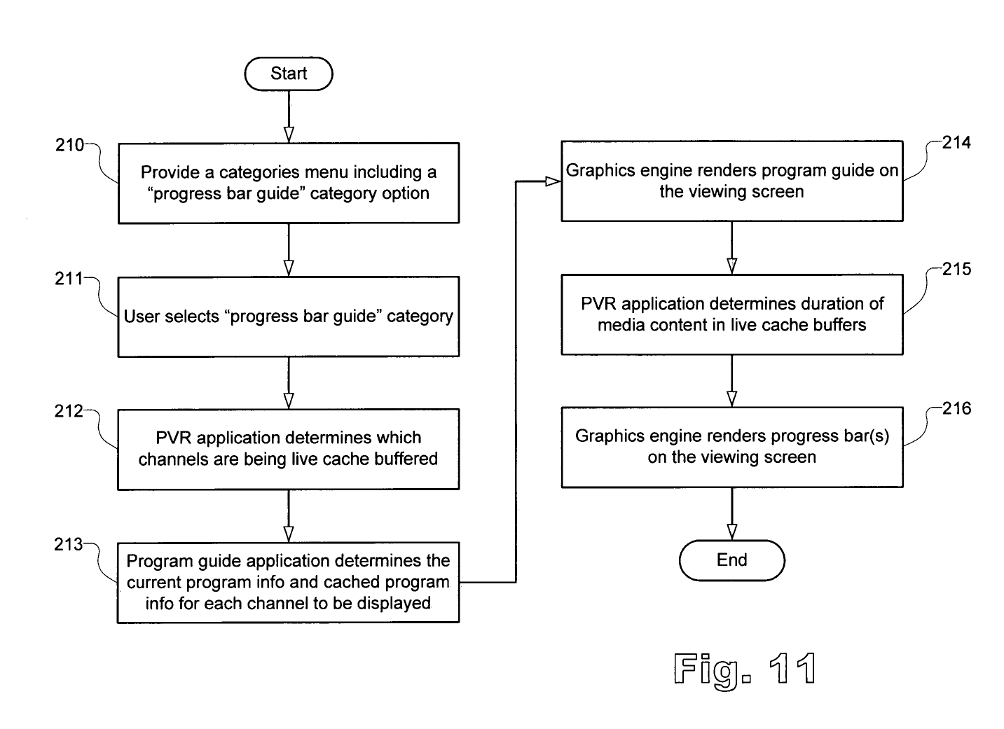

FIG. 11 is a flow chart illustrating an exemplary method of displaying a program guide showing program information related only to those channels being live cache buffered and with one or more superimposed progress bars, according to an exemplary embodiment of the present invention. The steps shown in FIG. 11 may be performed in any order and may be performed by various applications. Furthermore, the steps are exemplary only and may be added to or modified as best serves a particular application.

As shown in FIG. 11, the method preferably begins by providing a categories menu including a “progress bar guide” category option (step 210). The categories menu may be a GUI that is displayed on the viewing screen of the display device or it may be integrated into the user input device. The user may then select the “progress bar guide” category (step 211). Once the “progress bar guide” category is selected, the PVR application determines which channels are being live cache buffered (step 212). The program guide application then determines the current program information and cached program information for each channel to be displayed (step 213). With this information, the graphics engine may render the program guide on the viewing screen (step 214). The program information determined in step 213 is included in the program guide rendered in step 214.

The PVR application then determines the duration of the media content in the live, cache buffers (step 215). The graphics engine may then render one or more appropriately sized progress bars on the viewing screen (step 216).

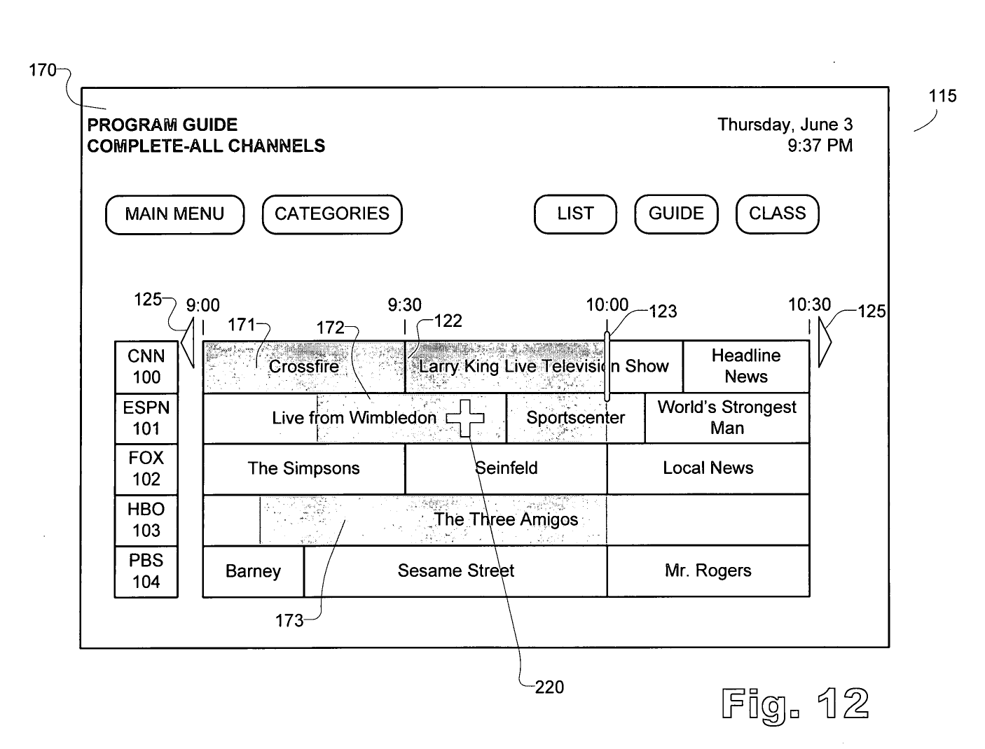

In one embodiment of the present invention, the user may permanently record any one of the media content instances stored in any of the live cache buffers (110; FIG. 1) and its corresponding program information. FIG. 12 illustrates an exemplary embodiment wherein the user may designate which media content instance is to be recorded by using the program guide (170) with the superimposed progress bars (171-173). In one embodiment, the user may move a record icon (220) such that it is positioned at any point within the media content instance that is to be permanently recorded. In an alternative embodiment, the user may position the progress indicator (123) instead of a record icon (220) over the particular media content instance that is to be permanently recorded. Once the record icon (120) is positioned within the media content that is to be permanently recorded, the user may press a record button (129; FIG. 2) on a user input device (e.g. 116; FIG. 2). The data stored in the live cache buffer (110) that corresponds to the selected media content instance is then copied from the live cache buffer (110) into a permanent buffer by the record application (113). The permanent buffer may be a part of the storage device (109; FIG. 1), for example.

For example, as shown in FIG. 12, a portion of Live at Wimbledon has been temporarily recorded in one of the live cache buffers (110). If the user desires to permanently record this portion of Live at Wimbledon, he or she may move the record icon (220) to any position between the beginning and end of the Live at Wimbledon media content instance, as indicated by the program guide (170). The user may then simply press the record button (129; FIG. 2) and the program and its corresponding program information are copied from the live cache buffer (110) to a permanent buffer by the record application (113).

The PVR, program guide, and record applications (111-113) may be implemented in hardware, software, firmware, or a combination thereof. For example, the applications (111-113) may be implemented in software or firmware that is stored in a memory and that is executed by a suitable instruction execution system. If implemented in hardware, as in an alternative embodiment, the PVR, program guide, and record applications (111-113) may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The PVR, program guide, and record applications (111-113) may comprise an ordered listing of executable instructions for implementing logical functions and may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The preceding description has been presented only to illustrate and describe embodiments of invention. It is not intended to be exhaustive or to limit the invention to any precise form disclosed. Many modifications and variations are possible in light of the above teaching. It is intended that the scope of the invention be defined by the following claims.

What is claimed is:

1. A method of providing information about media content being broadcast on multiple channels during a number of time segments, said media content including a plurality of media content instances, said method comprising:
displaying a program guide for said multiple channels, said program guide showing program information corresponding to a number of said plurality of media content instances; and
displaying a number of progress bars superimposed on top of said program guide, said progress bars graphically representing the duration of a recorded portion of said media content that is received by one or more tuners and stored in one or more corresponding live cache buffers.

2. The method of claim 1, wherein said step of displaying said program guide comprises displaying a number of rows of said program information, wherein each of said rows corresponds to one of said multiple channels.

3. The method of claim 2, wherein said number of rows is user-definable.

4. The method of claim 2, wherein said step of displaying said progress bars comprises superimposing said progress bars on top of one or more of said rows corresponding to one or more of said channels to which said tuners are tuned.

5. The method of claim 2, further comprising displaying an icon in one of said rows of said program guide to indicate that a corresponding channel of said one of said rows is being live cache buffered.

6. The method of claim 1, wherein said program guide occupies an entire viewing screen of a display device.

7. The method of claim 1, further comprising displaying one of said media content instances in a first portion of a viewing screen of a display device, wherein said program guide simultaneously occupies a second portion of said viewing screen of said display device.

8. The method of claim 1, wherein said plurality of media content instances comprise television programs.

9. The method of claim 1, wherein said number of time segments is user-definable.

10. The method of claim 1, wherein the duration of each of said time segments is user-definable.

11. The method of claim 1, wherein said step of displaying said program guide further comprises displaying a time scale corresponding to said number of time segments.

12. The method of claim 1, wherein said program information comprises a title for each of said plurality of said media content instances.

13. The method of claim 1, further comprising displaying said program information such that said program information is superimposed on top of said program guide.

14. The method of claim 1, wherein said program guide shows program information corresponding to each of said plurality of said media content instances.

15. The method of claim 1, wherein said program guide shows program information corresponding to media content instances being received by said one or more tuners.

16. The method of claim 1, further comprising displaying one or more scroll bars configured to scroll said program guide backwards and forwards such that additional time segments and corresponding program information are visible to a user.

17. The method of claim 1, wherein each of said live cache buffers is configured to store a pre-determined quantity of said media content, said pre-determined quantity corresponding to a live cache time window.

18. The method of claim 17, wherein the size of said live cache time window is user-definable.

19. The method of claim 1, wherein said step of displaying said progress bars further comprises increasing the length of said progress bars as time advances.

20. The method of claim 1, wherein said progress bars are configured to allow a user to view said recorded portion of said media content in a trick play mode.

21. The method of claim 1, further comprising displaying a progress indicator corresponding to a position in time of a particular media content instance currently being displayed, said position in time relative to said duration of said recorded portion of said media content.

22. The method of claim 21, wherein said progress indicator is a vertical line.

23. The method of claim 21, wherein said progress indicator is a triangle.

24. The method of claim 21, further comprising permanently recording in a permanent buffer one of said media content instances that is stored in said one or more live cache buffers.

25. The method of claim 24, wherein said step of permanently recording one of said media content instances comprises:
positioning a record icon at a location within any portion of said program guide corresponding to said one of said media content instances;
receiving an instruction to record from a user input device; and
copying said one of said media content instances from said live cache buffer to said permanent buffer.

26. The method of claim 25, wherein said step of permanently recording in a permanent buffer one of said media content instances that is stored in said live cache buffer further comprises permanently recording said program information corresponding to said one of said media content instances.

27. The method of claim 1, further comprising storing said program information in a program information database.

28. The method of claim 1, further comprising storing said program information in one of said live cache buffers.

29. The method of claim 1, further comprising:
displaying a categories menu including a selectable progress bar guide category;
wherein a selection of said progress bar guide category causes said program guide to show program information corresponding only to said channels having said media content that is stored in said one or more corresponding live cache buffers.

30. The method of claim 1, wherein said step of displaying said program guide comprises displaying a number of rows of said program information, wherein each of said rows corresponds to a channel being live cache buffered.

31. The method of claim 1, wherein said step of displaying said program guide for said multiple channel comprises:
building a list of available channels;
determining which of said available channels are to be included in said program guide;
determining said program information corresponding to said channels that are to be included in said program guide; and
rendering on a display device said program guide including said program information corresponding to said channels that are to be included in said program guide.

32. A system for providing information about media content being broadcast on multiple channels during a number of time segments, said media content including a plurality of media content instances, said system comprising:
one or more tuners for receiving a portion of said media content;
a storage device including one or more live cache buffers for temporarily storing said portion of said media content that is received by said one or more tuners;
a graphics engine configured to render graphics that are displayed on a display device; and
a processor configured to cause said graphics engine to display a program guide for said multiple channels and a number of progress bars superimposed on top of said program guide;
wherein said program guide for said multiple channels graphically shows program information corresponding to a number of said plurality of media content instances, wherein said progress bars graphically represent the duration of said portion of said media content that is stored in said one or more corresponding live cache buffers.

33. The system of claim 32, further comprising:
a memory unit including a number of applications;
wherein said processor is configured to use one or more of said number of applications to cause said graphics engine to display said program guide for said multiple channels and said progress bars.

34. The system of claim 33, wherein said number of applications includes a personal video recording (PVR) application configured to generate said progress bars.

35. The system of claim 33, wherein said number of applications includes a program guide application configured to generate said program guide.

36. The system of claim 32, wherein said program guide comprises a number of rows of said program information, wherein each of said rows corresponds to one of said multiple channels.

37. The system of claim 36, wherein said number of rows is user-definable.

38. The system of claim 36, wherein said progress bars are superimposed on top of one or more of said rows corresponding to one or more of said channels to which said tuners are tuned.

39. The system of claim 36, wherein an icon is displayed in one of said rows of said program guide to indicate that a corresponding channel of said one of said rows is being live cache buffered.

40. The system of claim 32, wherein said program guide occupies an entire viewing screen of a display device.

41. The system of claim 32, wherein one of said media content instances is displayed in a first portion of a viewing screen of a display device, wherein said program guide simultaneously occupies a second portion of said viewing screen of said display device.

42. The system of claim 32, wherein said plurality of media content instances comprise television programs.

43. The system of claim 32, wherein said number of time segments is user-definable.

44. The system of claim 32, wherein the duration of each of said time segments is user-definable.

45. The system of claim 32, wherein said program guide further shows a time scale corresponding to said number of time segments.

46. The system of claim 32, wherein said program information comprises a title for each of said plurality of said media content instances.

47. The system of claim 32, wherein said program information is superimposed on top of said program guide.

48. The system of claim 32, wherein said program guide shows program information corresponding to each of said plurality of said media content instances.

49. The system of claim 32, wherein said program guide shows program information corresponding to media content instances being received by said one or more tuners.

50. The system of claim 32, wherein said processor is further configured to cause said graphics engine to display one or more scroll bars configured to scroll said program guide backwards and forwards such that additional time segments and additional program information are visible to a user.

51. The system of claim 32, wherein each of said live cache buffers is configured to store a pre-determined quantity of said media content, said pre-determined quantity corresponding to a live cache time window.

52. The system of claim 51, wherein the size of said live cache time window is user-definable.

53. The system of claim 32, wherein the lengths of said progress bars increase as time advances.

54. The system of claim 32, wherein said progress bars are configured to allow a user to view said recorded portion of said media content in a trick play mode.

55. The system of claim 32, wherein said processor is further configured to cause said graphics engine to display a progress indicator corresponding to a position in time of a particular media content instance currently being displayed on said display device, said position in time relative to said duration of said temporarily recorded portion of said media content.

56. The system of claim 53, wherein said progress indicator is a vertical line.

57. The system of claim 53, wherein said progress indicator is a triangle.

58. The system of claim 32, wherein said system further comprises:
a permanent buffer; and
a record application;
wherein said processor uses said record application to permanently record in said permanent buffer one of said media content instances that is stored in one of said live cache buffers.

59. The system of claim 58, wherein a user invokes said permanent recording of said one of said media content instances by:
positioning a record icon at a location within any portion of said program guide corresponding to said one of said media content instances; and
sending a record command to said record application with a user input device.

60. The system of claim 59, wherein said user input device is a remote control.

61. The system of claim 32, wherein said processor causes said graphics engine to further display a categories menu including a selectable progress bar guide category, wherein a selection of said progress bar guide category causes said program guide to show program information corresponding only to said channels having said media content that is stored in said one or more corresponding live cache buffers.

62. The system of claim 32, wherein said program guide comprises a number of rows of said program information, wherein each of said rows corresponds to a channel being live cache buffered.

63. A graphical user interface (GUI) displayed on a display device, said GUI comprising:
a program guide, said program guide displaying program information corresponding to a number of a plurality of media content instances included in media content being broadcast on multiple channels during a number of time segments; and
a number of progress bars superimposed on top of said program guide, said progress bars graphically representing the duration of a recorded portion of said media content that is received by one or more tuners and stored in one or more corresponding live cache buffers.

64. The GUI of claim 63, wherein said program guide comprises a number of rows of said program information, wherein each of said rows corresponds to one of said multiple channels.

65. The GUI of claim 64, wherein said number of rows is user-definable.

66. The GUI of claim 64, wherein said progress bars are superimposed on top of one or more of said rows corresponding to one or more of said channels to which said tuners are tuned.

67. The GUI of claim 64, further comprising an icon displayed in one of said rows of said program guide to indicate that a corresponding channel of said one of said rows is being live cache buffered.

68. The GUI of claim 63, wherein said program guide occupies an entire viewing screen of said display device.

69. The GUI of claim 63, wherein one of said media content instances is displayed in a first portion of a viewing screen of said display device, wherein said program guide simultaneously occupies a second portion of said viewing screen of said display device.

70. The GUI of claim 63, wherein said plurality of media content instances comprise television programs.

71. The GUI of claim 63, wherein said number of time segments is user-definable.

72. The GUI of claim 63, wherein the duration of each of said time segments is user-definable.

73. The GUI of claim 63, wherein said program guide further shows a time scale corresponding to said number of time segments.

74. The GUI of claim 63, wherein said program information comprises a title for each of said plurality of said media content instances.

75. The GUI of claim 63, wherein said program information is superimposed on top of said program guide.

76. The GUI of claim 63, wherein said program guide shows program information corresponding to each of said plurality of said media content instances.

77. The GUI of claim 63, wherein said program guide shows program information corresponding to media content instances being received by said one or more tuners.

78. The GUI of claim 63, further comprising one or more scroll bars to scroll said program guide backwards and forwards such that additional time segments and additional program information are visible to a user.

79. The GUI of claim 63, wherein said live cache buffers are configured to store a pre-determined quantity of said media content, said pre-determined quantity corresponding to a live cache time window.

80. The GUI of claim 63, wherein the size of said live cache time window is user-definable.

81. The GUI of claim 63, wherein the length of said progress bars increase as time advances.

82. The GUI of claim 63, wherein said progress bars are further configured to allow a user to view said recorded portion of said media content in a trick play mode.

83. The GUI of claim 63, further comprising a progress indicator configured to correspond to a position in time of a particular media content instance currently being displayed on said display device, said position in time relative to said duration of said recorded portion of said media content.

84. The GUI of claim 83, wherein said progress indicator is a vertical line or a triangle.

85. The GUI of claim 63, further comprising a categories menu including a selectable progress bar guide category, wherein a selection of said progress bar guide category causes said program guide to show program information corresponding only to said channels having said media content that is stored in said one or more corresponding live cache buffers.

86. The GUI of claim 63, wherein said program guide comprises a number of rows of said program information, wherein each of said rows corresponds to a channel being live cache buffered.

87. The GUI of claim 63, further comprising a record icon positioned at a location within any portion of said program guide corresponding to one of said media content instances that is to be permanently recorded.

88. A system for providing information about media content being broadcast on multiple channels during a number of time segments, said media content including a plurality of media content instances, said method comprising:
means for displaying a program guide for said multiple channels, said program guide showing program information corresponding to a number of said plurality of media content instances; and
means for displaying a number of progress bars superimposed on top of said program guide, said progress bars graphically representing the duration of a recorded portion of said media content that is received by one or more tuners and stored in one or more corresponding live cache buffers.

89. The system of claim 88, wherein said means for displaying said program guide comprises means for displaying a number of rows of said program information, wherein each of said rows corresponds to one of said multiple channels.

90. The system of claim 89, wherein said means for displaying said progress bars comprises means for superimposing said progress bars on top of one or more of said rows corresponding to one or more of said channels to which said tuners are tuned.

91. The system of claim 89, further comprising mean for displaying an icon in one of said rows of said program guide to indicate that a corresponding channel of said one of said rows is being live cache buffered.

92. The system of claim 88, further comprising means for displaying one or more scroll bars configured to scroll said program guide backwards and forwards such that additional time segments and corresponding program information are visible to a user.

93. The system of claim 88, wherein said means for displaying said progress bars further comprises means for increasing the length of said progress bars as time advances.

94. The system of claim 88, further comprising means for displaying a progress indicator corresponding to a position in time of a particular media content instance currently being displayed, said position in time relative to said duration of said recorded portion of said media content.

95. The system of claim 88, further comprising means for permanently recording in a permanent buffer one of said media content instances that is stored in said one or more live cache buffers.

96. The system of claim 95, wherein said means for permanently recording one of said media content instances comprises:
means for positioning a record icon at a location within any portion of said program guide corresponding to said one of said media content instances;
means for receiving an instruction to record from a user input device; and
means for copying said one of said media content instances from said live cache buffer to said permanent buffer.

97. The system of claim 88, further comprising:
means for displaying a categories menu including a selectable progress bar guide category;
wherein a selection of said progress bar guide category causes said program guide to show program information corresponding only to said channels having said media content that is stored in said one or more corresponding live cache buffers.

98. The system of claim 88, wherein said means for displaying said program guide comprises means for displaying a number of rows of said program information, wherein each of said rows corresponds to a channel being live cache buffered.
